(19) United States
(12) Patent Application Publication
(10) Pub. No.: US 2020/0269369 A1
(43) Pub. Date: Aug. 27, 2020

(54) WORK SURFACE MOUNTABLE T-TRACK

(71) Applicant: Robert N. Poole, Coronado, CA (US)

(72) Inventor: Robert N. Poole, Coronado, CA (US)

(21) Appl. No.: 16/800,283

(22) Filed: Feb. 25, 2020

Related U.S. Application Data
(60) Provisional application No. 62/810,119, filed on Feb. 25, 2019.

(51) Int. Cl. B23Q 1/42; B23Q 1/58

(52) U.S. Cl. CPC B23Q 1/42; B23Q 1/58

(57) ABSTRACT

A tool mounting track embedded in the surface of a work table is formed. The track includes an elongated metal bar with a cross-section including an upwardly opening channel defined between inwardly directed flanges and outwardly extending side grooves immediately below the flanges forming an elongated inverted T shaped track, all of the upwardly opening channel, the inwardly directed flanges, and the side grooves extending substantially the length of the elongated metal bar. At least one open area of the elongated metal bar where a portion of the inwardly directed flanges is omitted to provide an entry for a downwardly extending rectangular tool foot. The elongated metal bar is positioned between edges of the work table and spaced therefrom.

### CROSS-REFERENCE TO RELATED APPLICATION

This application claims the benefit of U.S. Provisional Patent Application No. 62/810,119, filed 25 Feb. 2019.

### FIELD OF THE INVENTION

This invention relates to t-track components mountable in a work surface and the resulting structure.

### BACKGROUND OF THE INVENTION

Work tables for quick mounting various tools and/or work-pieces are well-known in the art. One of the major problems is that the tools can only be mounted in specific locations and generally those locations are fixed and cannot be varied. In some instances, multiple tools can be mounted by a single system but the tools cannot be readily changed or moved in relative positions.

It would be highly advantageous, therefore, to remedy this and other deficiencies inherent in the prior art. Accordingly, it is an object of the present invention to provide new and improved tool and/or work-piece mounting tracks mountable in work tables or surfaces.

It is another object of the present invention to provide new and improved tool and/or work-piece mounting tracks in which the mounted items can be quickly and easily moved and/or interchanged.

It is another object of the present invention to provide new and improved tool and/or work-piece mounting tracks that allow quick mounting, tool positioning, and removal or interchange.

It is another object of the present invention to provide new and improved mounting tracks that can be inlaid in work surfaces to form 90-degree intersections.

### SUMMARY OF THE INVENTION

Briefly to achieve the desired objects and advantages of the instant invention, a tool mounting track embedded in the surface of a work table is provided. The track includes an elongated metal bar with a cross-section having an upwardly opening channel defined between inwardly directed flanges and outwardly extending side grooves immediately below the flanges forming an elongated inverted T shaped track. All of the upwardly opening channel, the inwardly directed flanges, and the side grooves extend substantially (except for open areas) the length of the elongated metal bar. At least one open area of the elongated metal bar is formed where a portion of the inwardly directed flanges is omitted to provide an entry for a downwardly extending rectangular tool foot.

The desired objects and advantages of the instant invention are further achieved in a preferred example of a work table with a tool mounting track embedded therein. The table includes a work surface with at least one elongated groove formed in the surface, the groove extending between edges of the table but spaced from the edges. An elongated metal bar is formed with a cross-section including an upwardly opening channel defined between inwardly directed flanges and outwardly extending side grooves immediately below the flanges forming an elongated inverted T shaped track. All of the upwardly opening channel, the inwardly directed flanges, and the side grooves extend substantially (except for open areas) the length of the elongated metal bar. At least one open area of the elongated metal bar where a portion of the inwardly directed flanges is omitted to provide an entry for a downwardly extending rectangular tool foot, and the elongated metal bar extends longitudinally approximately the length of the elongated groove and is positioned within the elongated groove with the elongated inverted T shaped track opening upwardly. The elongated metal bar is fixedly attached to the work surface of the table in the elongated groove.

The desired objects and advantages of the instant invention are further achieved in a preferred method of providing a work table with at least one tool mounting track embedded therein. The method includes the steps of providing a work table with a work surface, the work surface having edges, and forming at least one elongated groove in the work surface, the groove positioned between opposed edges of the work surface and spaced from the opposed edges. The method further includes the steps of forming at least one elongated metal bar with a cross-section including an upwardly opening channel defined between inwardly directed flanges and outwardly extending side grooves immediately below the flanges forming an elongated inverted T shaped track, all of the upwardly opening channel, the inwardly directed flanges, and the side grooves extending substantially the length of the elongated metal bar. At least one open area of the elongated metal bar is formed where a portion of the inwardly directed flanges is omitted to provide an entry for a downwardly extending rectangular tool foot. The elongated metal bar extends longitudinally approximately the length of the elongated groove and is positioned within the elongated groove with the elongated inverted T shaped track opening upwardly. The method further includes a step of fixedly attaching the at least one elongated metal bar to the work surface of the work table in the elongated groove.

### BRIEF DESCRIPTION OF THE DRAWINGS

Specific objects and advantages of the invention will become readily apparent to those skilled in the art from the following detailed description of a preferred embodiment thereof, taken in conjunction with the drawings in which:

FIG. 1 is a perspective view of a work table with tool mounting apparatus embedded therein, in accordance with the present invention;

FIGS. 2 is a side view of a work table tool mounting track, in accordance with the present invention;

FIG. 3 is a cross-sectional view of the work table tool mounting track of FIG. 2, as seen from the line 3-3;

FIG. 4 is a cross-sectional view of the work table tool mounting track of FIG. 3, with the foot of a representative tool or work-piece positioned therein;

FIG. 5 is a cross-sectional view of the work table tool mounting track of FIG. 2, as seen from the line 5-5;

FIG. 6 is a perspective view of a work table with the present tool mounting track positioned parallel to and adjacent a forward edge of the table;

FIG. 7 is a perspective view of a work table with the present tool mounting track positioned parallel to and embedded in a forward edge of the table;

FIG. 8 is a perspective view of a work table with tool mounting tracks embedded therein to form a work-piece gripping arrangement and work-piece clamped in place;

FIG. 9 is a perspective view of tool mounting tracks embedded in a work surface to form a 90 degree junction, in accordance with the present invention;

FIG. 10 is a perspective view of a traditional tool track intersection;

FIG. 11 is a cross-sectional view of a specific embodiment of the present tool mounting track illustrating a structure for mounting the track;

FIG. 12 is a perspective view in cross-section illustrating a portion of the specific tool mounting track of FIG. 11; and

FIG. 13 is a partial sectional-view of the specific tool mounting track of FIG. 11 illustrating the track mounting arrangement and a representative tool mounted in the track.

### DETAILED DESCRIPTION OF A PREFERRED EMBODIMENT

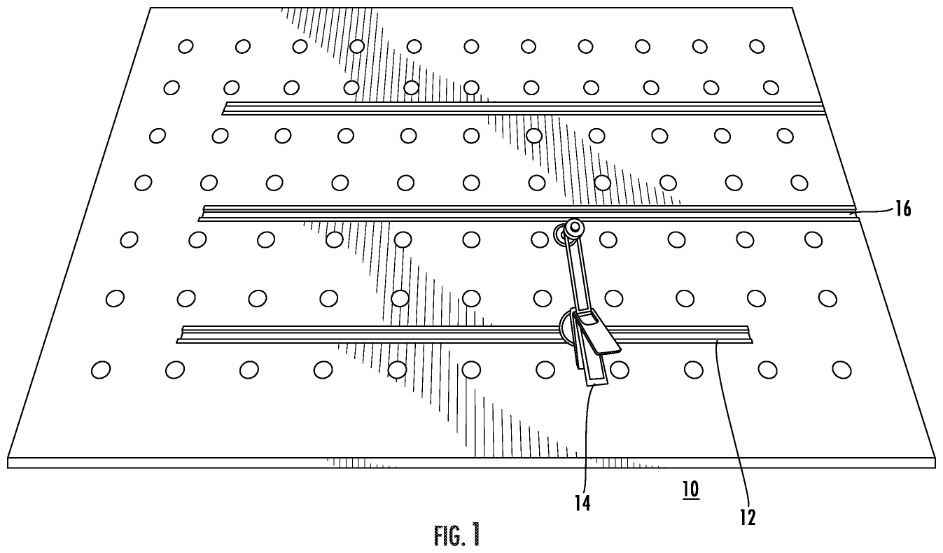

Turning to FIG. 1, a work table, generally designated 10, is provided to illustrate one potential use or mounting for the present tool mounting track or tracks, one embodiment of which is illustrated and designated 12. Generally, the term “tool track 12” refers to the elongated opening or track formed within an elongated metal bar or element 11. An assembly 14, representative of a quick-mounting tool, is illustrated to aid in understanding the invention. Assembly 14 includes a portion that rests on the surface of work table 10 and a downwardly extending rectangular foot (not shown) that can be inserted in a mounting track and grip the upper edges of the mounting track between the foot and the portion that rests on the surface to firmly hold assembly 14 in any selected position along the mounting track. The foot can be released so that assembly 14 can be slid along a mounting track to any desired location. Many different tools and even work pieces can be quick-mounted in a similar fashion. Additionally, while a work table is illustrated, it will be understood that any work surface, such as concrete beds and the like, as well as wood or metal surfaces can have track 12 of the present invention imbedded therein. Thus, the term “work table” is intended to include any area having a surface on which tool work is performed. Since no edge is required for use, work surfaces without assessible edges can employ the present invention.

A tool track 16 is also illustrated to accentuate the difference between prior tool tracks and the present invention. Tool track 16 is embedded in the surface of work table 10 approximately in the center, from top-to-bottom and extends to the right-hand edge in FIG. 1. Tool track 16 must have an edge access because the foot of tools similar to assembly 14 can only be inserted in track 16 from an edge of the work table. Once the foot is inserted, the clamping feature can be released and assembly 14 can be slid along track 16 to any desired location. The problem here is that when additional quick-mounting tools or work pieces are mounted in the same track, they cannot easily be arranged in any desired position. For example, if another quick-mounting tool or work piece is to be positioned to the left of a tool already positioned in track 16, the first tool must be removed, the second tool inserted and moved to the desired position, and then the first tool must be reinserted and positioned at the desired location. Each time another tool or work piece is to be mounted in track 16 additional time and effort must be expended to correctly position all of the items. Also, track 16 must extend to an edge of the work table, which severely limits its usefulness and versatility. That is, each item to be mounted by track 16 must be moved to the edge of work table 10, the foot inserted, and then slid along track 16, possibly as far as close to the opposite edge of work table 10.

Directing attention to mounting track 12, constructed in accordance with the present invention, mounting track 12 is embedded in a channel or slot in a central area of the surface of work table 10 with the upper surfaces of track 12 flush with the upper surface of table 10. Specifically, there is no need to extend mounting track 12 to an edge of work table 10, which vastly improves its usefulness and versatility. Referring additionally to FIGS. 2-4, views of track 12/bar 11 in an unmounted position are illustrated to better explain the configuration and operation. In some instances, for ease of understanding, the entire structure including track 12 and bar 11 may be referred to simply as track 12. Referring specifically to FIG. 2, a side view of mounting track 12 is illustrated. Generally, in its simplest form, mounting track 12 is produced by extrusion of a metal bar 11, such as aluminum or the like, with the opening designated tool track 12 formed therein. The extruded metal bar 11 is then cut to the desired length and milled or otherwise processed to provide the desired form.

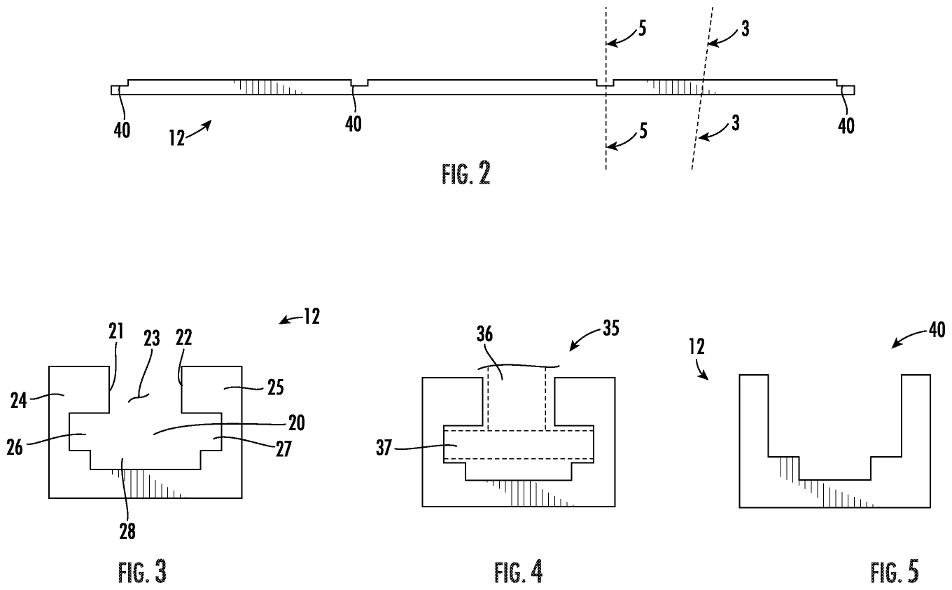

Referring specifically to FIG. 3, the general cross-section of mounting track 12 is illustrated. With the understanding that all of the sides and grooves extend the length of the extrusion (i.e. longitudinally along bar 11), a central opening 20 is defined. Opening 20 initially includes spaced apart parallel sides 21 and 22 extending through the upper surface, toward the bottom surface, and then outwardly toward the sides of track 12 to define an upwardly opening channel 23 between inwardly directed opposed flanges 24 and 25. Sides 21 and 22 are then directed downwardly toward the bottom surface of track 12 and inwardly toward the center of track 12 to form side grooves 26 and 27 immediately below flanges 24 and 25, respectively. Sides 21 and 22 then extend downwardly a short distance toward the lower surface of track 12 and inwardly to meet in the center and define a depression 28 in the lower surface of opening 20. Thus, upwardly opening channel 23 between flanges 24 and 25 and side grooves 26 and 27 immediately below flanges 24 and 25 form an inverted T shaped track.

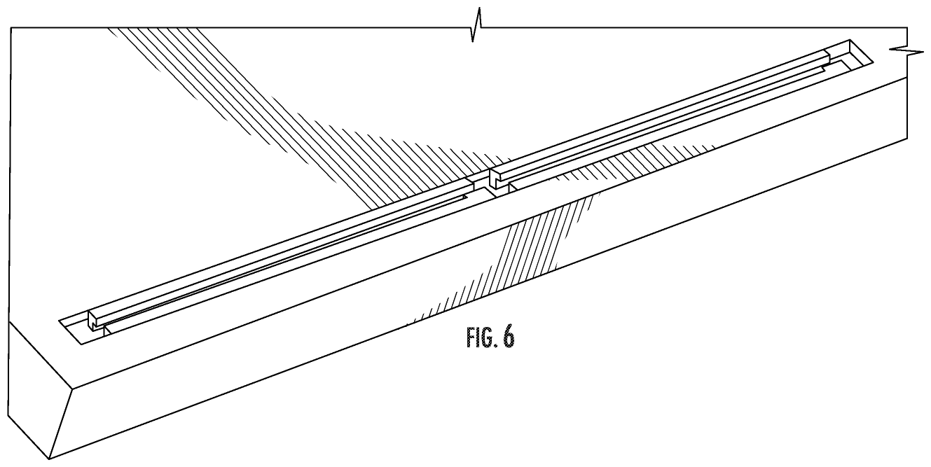

Referring additionally to FIG. 4, a representative foot 35 for a quick-mount tool or work-piece is illustrated engaged in central opening 20 of track 12. Foot 35 includes a perpendicular component 36 with the quick-mount tool or work-piece (not shown) attached at the upper end. A wider portion 37, which is generally rectangular in shape, extends outwardly into side grooves 26 and 27 of opening 20. In operation, foot 35 is free to slide longitudinally along elongated opening 20. When a desired position is reached, wider portion 37 is retracted against flanges 24 and 25 with a portion of the quick-mount tool or work-piece butting firmly against the upper surface of track 12 to pinch flanges 24 and 25 tightly between wider portion 37 and the lower surface of the quick-mount tool or work-piece. Depression 28 is provided to reduce friction between foot 35 and the surfaces of opening 20 during longitudinal movements and to allow for any downward extensions of foot 35 (e.g. mounting elements, etc.).

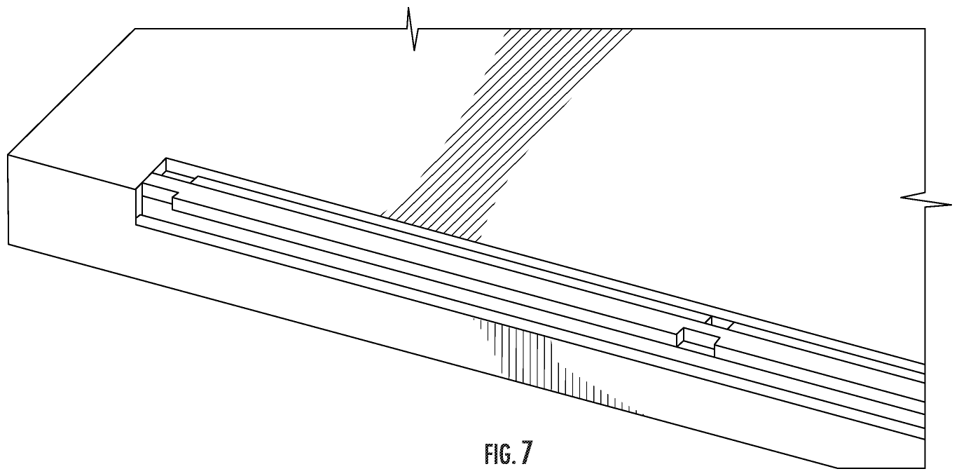

Referring back to FIG. 2, a major portion of the novelty in the present invention is illustrated. Engaging-slots or openings 40 are formed in track 12 at specified locations along the length. For example, in FIG. 2, at each end and at two spaced apart locations midway between the ends. In a preferred embodiment, engaging slots or openings 40 are spaced approximately 12 inches apart and on each end of the T-track, but any desired spacing is included in the concept. Referring additionally to FIG. 5, a cross-section of track 12 is illustrated to show that engaging-slots 40 are formed primarily by removing a short section of flanges 24 and 25. Generally, wider portion 37 of foot 35 is rectangular so that the longitudinal length and cross-sectional length are approximately equal. This allows the quick-mount tool or work-piece to be engaged in track 12 in several different orientations. Thus, when forming engaging-slots 40, the short section of flanges 24 and 25 that is removed is slightly longer than the total cross-sectional length of side grooves 26 and 27. In the preferred process of removing portions of flanges 24 and 25, track 12 is simply milled straight across from one side to the other (note the slight depression at the slot positions in FIG. 2).

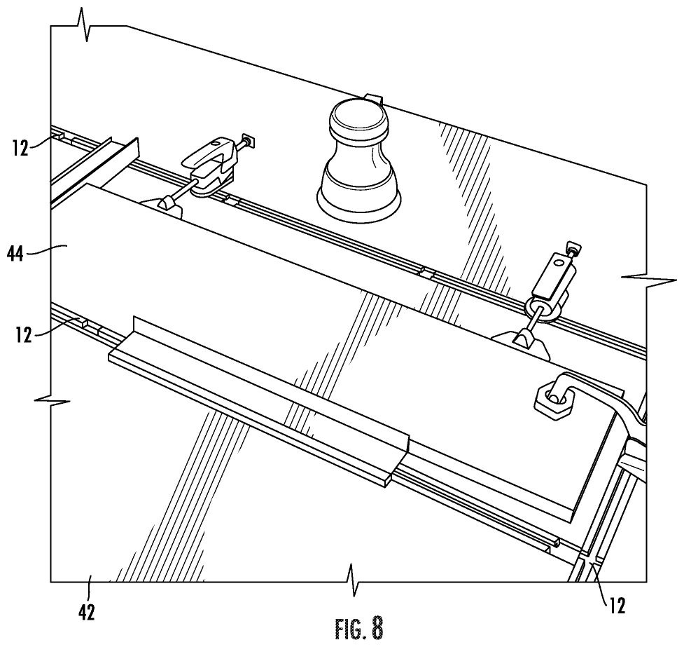

By forming a plurality of engaging-slots 40 spaced longitudinally along track 12, quick-mount tools or work-pieces can be easily and quickly positioned at substantially any location of a work table. Also, interchanging or repositioning quick-mount tools or work-pieces does not require the removal or movement of quick-mount tools or work-pieces that are already mounted. Further, there is no need to extend the mounting track to an edge of the work table, which greatly increases its usefulness and versatility. For example, as illustrated in FIG. 6, the new and novel mounting track can be positioned adjacent an edge of a work table. Also, as illustrated in FIG, 7, the mounting track can be positioned in an edge of a work table, although work tools need not be engaged in the mounting track at an end of the mounting track.

Turning to FIG. 8, a work table 42 with several tool mounting tracks 12 embedded therein to form a work-piece gripping arrangement is illustrated. In this specific example, tool mounting tracks 12 are embedded to form a rectangular arrangement with the tracks forming 90 degree intersections at the coroners. A work-piece 44 is clamped in the rectangle by a plurality of strategically placed clamps and holders engaged in the surrounding tool mounting tracks 12. This arrangement is included to illustrate one of the many possible uses and arrangements that can be formed with the present highly useful and versatile tool mounting track. It will also be understood that multiple parallel tracks 12 can be used when large work-pieces are desired to be mounted. For example, large workpieces can be mounted on concrete beds (work table), and may require parallel feet for proper support. In this case, multiple parallel tracks embedded in the surface of the concrete bed (work table) allow receipt of wider workpieces requiring multiple feet for support.

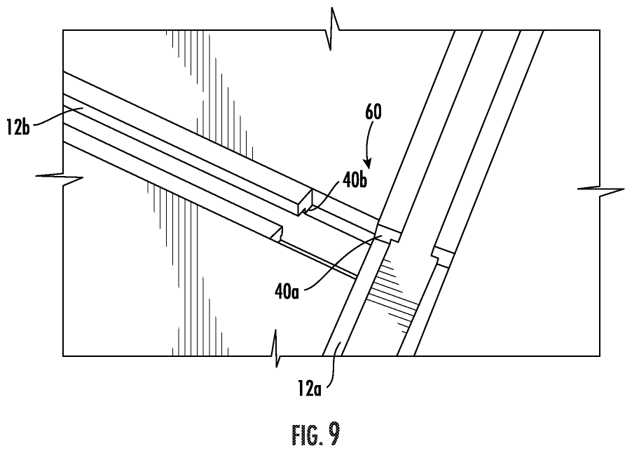

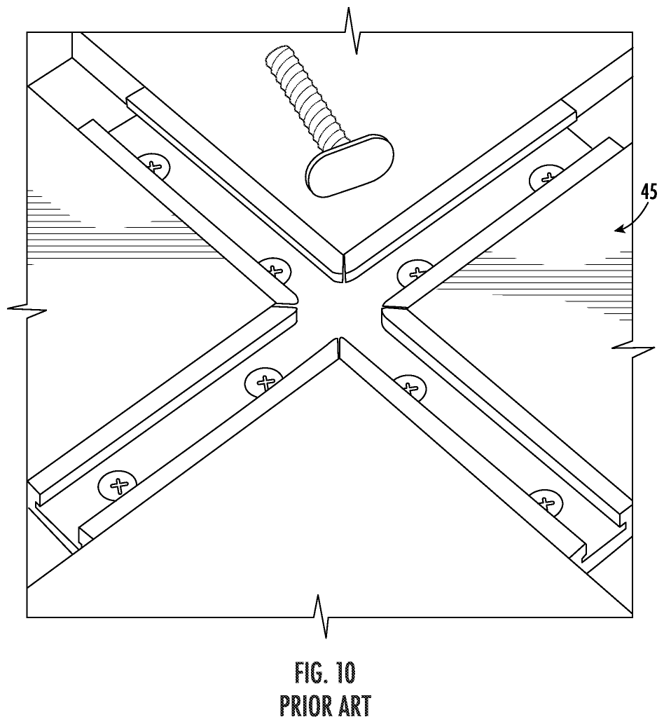

Referring additionally to FIG. 9, a 90 degree junction, generally designated 60, is illustrated in detail. Junction 60 is formed by intersecting a first tool mounting track 12a and a second tool mounting track 12b . In this arrangement an engaging slot 40b is formed at the end of tool mounting track 12b butting against an engaging slot 40a in a mid-portion of tool mounting track 12a . This arrangement allows for the easy insertion, removal, and/or changing tracks of tools or work-pieces mounted in the tracks.

A traditional intersection 45 in prior art tracks is illustrated in FIG. 10. Prior art tracks required separate junction piece 45 to provide an intersection between tracks. Traditional T-tracks cannot be inlayed into a work table or other surface without an exit point on the end (i.e. at an edge of the work table or other surface). It will be understood that T-tracks are traditionally mounted by inserting screws 46 through holes in the tracks, as illustrated.

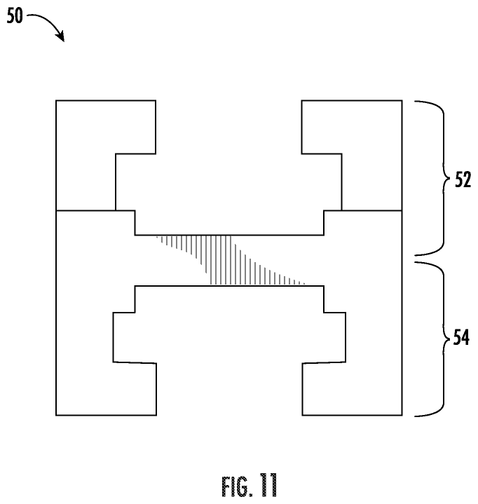

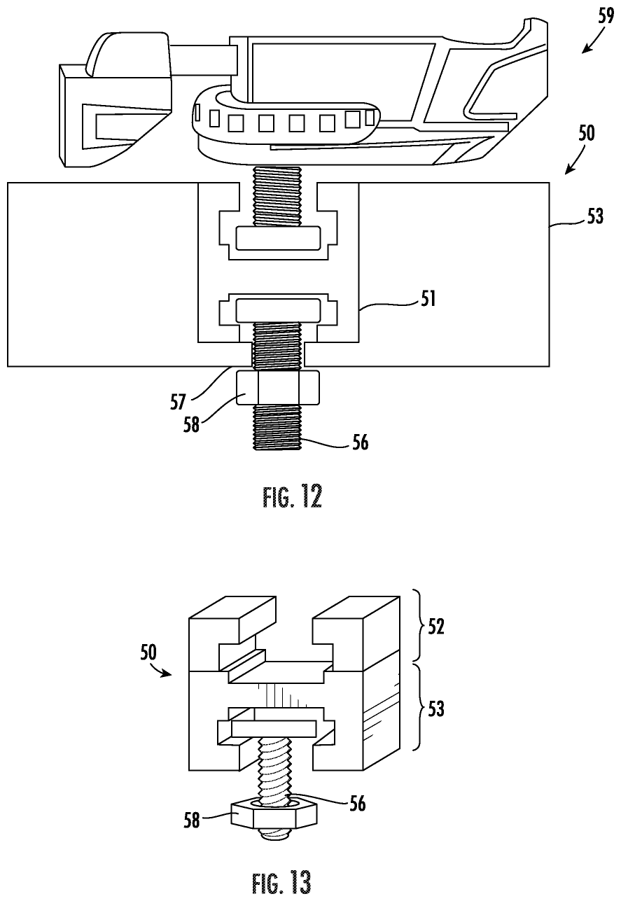

Turning to FIG. 11, a cross-sectional view of another embodiment of a mounting track 50 is illustrated. Mounting track 50, includes, generally back-to-back double tracks with a first track 52 opening upwardly and a second integrally formed track 54 opening downwardly. Mounting track 50, is preferably produced by extrusion from aluminum or other workable metals. Primarily, mounting track 50 is designed for ease in mounting in a work table or the like. In the mounting operation, as can be seen by additional reference to FIGS. 12 and 13, a groove 51 is formed in the surface of, for example, a work table 53. Groove 51 has a depth that is approximately the total height of mounting track 50. Bolts 56, preferably with generally square heads (e.g. carriage bolts and the like), are engaged in track 54 (i.e. opening downwardly) and moved to selected locations. Holes 57 are formed in the bottom of groove 51 and the downwardly hanging bolts 56 are inserted through holes 57 with mounting track 50 positioned in groove 51. Nuts 58 are threadedly engaged on downwardly hanging bolts 56 and tightened to firmly hold mounting track 50 in groove 51. Upper track 52 can then be used to mount quick-mount tools or work-pieces, such as example 59. Also, in the preferred embodiment upper track 52 will have slots 40 positioned at selected locations for the quick and easy mounting of quick-mount tools or work-pieces. Track 50 with upper track 52 and integrally formed lower track 54 provides a much more rugged mounting arrangement which allows greater clamping pressure (pull force on the tracks). While the novel mounting of double track 50 has many advantages, single tracks 12 as illustrated in FIG. 2 and throughout the explanation can be mounted with screws from the top of the table as in the traditional method.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A tool mounting track embedded in the surface of a work table, the track comprising;
an elongated metal bar with a cross-section including an upwardly opening channel defined between inwardly directed flanges and outwardly extending side grooves immediately below the flanges forming an elongated inverted T shaped track, all of the upwardly opening channel, the inwardly directed flanges, and the side grooves extending substantially the length of the elongated metal bar; and
at least one open area of the elongated metal bar where a portion of the inwardly directed flanges is omitted to provide an entry for a downwardly extending rectangular tool foot.

2. The tool mounting track as claimed in claim 1 wherein a plurality of open areas are provided, each area with a portion of the inwardly directed flanges omitted to provide an entry for a downwardly extending rectangular tool foot.

3. The tool mounting track as claimed in claim 2 wherein one of the plurality of open areas is positioned at each end of the elongated inverted T shaped track.

4. The tool mounting track as claimed in claim 3 wherein remaining open areas of the plurality of open areas are spaced apart between the ends of the elongated inverted T shaped track.

5. The tool mounting track as claimed in claim 4 wherein the spacing between the remaining open areas is 12 inches.

6. The tool mounting track as claimed in claim 1 wherein the elongated metal bar further includes a longitudinally extending depression in the lower surface of the elongated inverted T shaped track.

7. The tool mounting track as claimed in claim 1 wherein the open areas are formed to receive a tool foot with a wider portion that is rectangular so that the longitudinal length and cross-sectional length are approximately equal.

8. The tool mounting track as claimed in claim 1 wherein a work table includes an elongated slot in the surface and the tool mounting track is embedded in the elongated slot in an upwardly opening orientation.

9. The tool mounting track as claimed in claim 8 wherein holes are included along the lower surface of elongated inverted T shaped track for fixedly mounting the elongated inverted T shaped track in the elongated slot.

10. The tool mounting track as claimed in claim 1 wherein the tool mounting track further includes a mounting portion integrally attached to a lower surface of the elongated metal bar, the mounting portion defining an elongated downwardly opening T shaped track.

11. A work table with a tool mounting track embedded therein, the table comprising;
a work surface with at least one elongated groove formed in the surface, the groove extending between edges of the table but spaced from the edges:
an elongated metal bar with a cross-section including an upwardly opening channel defined between inwardly directed flanges and outwardly extending side grooves immediately below the flanges forming an elongated inverted T shaped track, all of the upwardly opening channel, the inwardly directed flanges, and the side grooves extending substantially the length of the elongated metal bar, at least one open area of the elongated metal bar where a portion of the inwardly directed flanges is omitted to provide an entry for a downwardly extending rectangular tool foot, and the elongated metal bar extending longitudinally approximately the length of the elongated groove and positioned within the elongated groove with the elongated inverted T shaped track opening upwardly; and
the elongated metal bar being fixedly attached to the work surface of the table in the elongated groove.

12. The work table with a tool mounting track embedded therein as claimed in claim 11 wherein the work surface includes first and second elongated grooves formed in the surface and intersecting each other at a right angle junction, a first elongated metal bar with a cross-section including an upwardly opening channel embedded in the first elongated groove and a second elongated metal bar with a cross-section including an upwardly opening channel embedded in the second elongated groove, the first elongated metal bar including an open area at the right angle junction and the second elongated metal bar including an open area at an end positioned at the junction, whereby the open areas of the first elongated metal bar and the second elongated metal bar cooperate to form a common open area.

13. A method of providing a work table with at least one tool mounting track embedded therein, the method comprising the steps of;
providing a work table with a work surface, the work surface having edges;
forming at least one elongated groove in the work surface, the groove positioned between opposed edges of the work surface and spaced from the opposed edges:
forming at least one elongated metal bar with a cross-section including an upwardly opening channel defined between inwardly directed flanges and outwardly extending side grooves immediately below the flanges forming an elongated inverted T shaped track, all of the upwardly opening channel, the inwardly directed flanges, and the side grooves extending substantially the length of the elongated metal bar, at least one open area of the elongated metal bar where a portion of the inwardly directed flanges is omitted to provide an entry for a downwardly extending rectangular tool foot, and the at least one elongated metal bar extending longitudinally approximately the length of the elongated groove and positioned within the elongated groove with the elongated inverted T shaped track opening upwardly; and
fixedly attaching the at least one elongated metal bar to the work surface of the work table in the elongated groove.

14. The method as claimed in claim 13 wherein the step of forming the at least one elongated metal bar includes extruding the metal bar.

15. The method as claimed in claim 14 wherein the step of forming the at least one elongated metal bar with at least one opening includes the omitted portion of the inwardly directed flanges being removed after extrusion to provide an entry for a downwardly extending rectangular tool foot.

16. The method as claimed in claim 15 wherein the step of removing the inwardly directed flanges includes milling the flanges.

17. The method as claimed in claim 13 wherein the step of fixedly attaching the at least one elongated metal bar to the work surface includes forming holes in a lower surface of the elongated inverted T shaped track and threading screws through the holes and into the work table.

18. The method as claimed in claim 13 wherein the step of forming the at least one elongated metal bar further includes forming a mounting portion integrally attached to a lower surface of the at least one elongated metal bar, the mounting portion defining an elongated downwardly opening T shaped track.

19. The method as claimed in claim 18 wherein the step of forming the at least one elongated groove in the work surface includes forming the at least one elongated groove deep enough to receive the elongated metal bar with the mounting portion so that an upper surface of the elongated metal bar is flush with the work surface and forming holes through a lower surface of the at least one elongated groove, engaging heads of bolts in the mounting portion and extending bodies of the bolts through the holes through the lower surface, and threading nuts onto the bodies of the bolts to fixedly attach the at least one elongated metal bar to the work surface.

20. The method as claimed in claim 13 wherein the step of forming at least one elongated groove in the work surface includes forming first and second elongated grooves in the work surface so as to intersect each other at a right angle junction, the step of forming at least one elongated metal bar includes forming a first elongated metal bar with a cross-section including an upwardly opening channel and a second elongated metal bar with a cross-section including an upwardly opening channel, the first elongated metal bar including an open area at the right angle junction and the second elongated metal bar including an open area at an end positioned at the junction, and the step of fixedly attaching the at least one elongated metal bar to the work surface includes embedding the first elongated metal bar in the first elongated groove and embedding the second elongated metal bar in the second elongated groove, whereby the open areas of the first elongated metal bar and the second elongated metal bar cooperate to form a common open area for transferring movement of a tool foot from the first elongated metal bar to the second elongated metal bar and vice versa.
